(19) United States
(12) Patent Application Publication
(10) Pub. No.: US 2012/0181337 A1
(43) Pub. Date: Jul. 19, 2012

(54) BARCODE READING APPARATUS AND BARCODE READING METHOD

(75) Inventors: Po-Chang Chen, New Taipei City (TW); Hsin-Yueh Sung, New Taipei City (TW); Chir-Weei Chang, Taoyuan County (TW); Chuan-Chung Chang, Hsinchu County (TW)

(73) Assignee: INDUSTRIAL TECHNOLOGY RESEARCH INSTITUTE, Hsinchu (TW)

(21) Appl. No.: 13/091,156

(22) Filed: Apr. 21, 2011

(30) Foreign Application Priority Data
Jan. 14, 2011 (TW) 100101463

(51) Int. Cl. G06K 7/14; G06K 7/01

(52) U.S. Cl. 235/438; 235/462.22

(57) ABSTRACT

A barcode reading apparatus adapted to detect a barcode is provided. The barcode reading apparatus includes an imaging lens, an image sensor, and a barcode decoder. The imaging lens has a spherical aberration to extend a depth of field of the imaging lens. The imaging lens is configured to image the barcode onto the image sensor. The image sensor converts an image of the barcode into a barcode signal. The barcode decoder is configured to decode the barcode signal to obtain information represented by the barcode. A barcode reading method is also provided.

### CROSS-REFERENCE TO RELATED APPLICATION

This application claims the priority benefit of Taiwan application serial no. 100101463, filed on Jan. 14, 2011. The entirety of the above-mentioned patent application is hereby incorporated by reference herein and made a part of this specification.

### TECHNICAL FIELD

The disclosure relates to a reading apparatus and a reading method. Particularly, the disclosure relates to a barcode reading apparatus and a barcode reading method.

### BACKGROUND

With rapid development of industry and commerce, people's pace of life is accelerated, and people starts thinking how to save time on trivial matters to gain more applicable time. Therefore, a barcode technique is accordingly developed. By using a barcode reading apparatus, a user can quickly and correctly input serial information into a machine or a computer without manually inputting it one by one through an input device, e.g. a keyboard. Therefore, by using the barcode, not only is time saved, but also human operation errors can be effectively avoided.

Today, the barcodes have been widely used in industry and commerce and people's livelihood, though with increasing demand for information capacity, the barcode is developed from a one-dimensional barcode (for example, JAN13) to a two-dimensional barcode (for example, a matrix code, PDF417, etc). Moreover, a bar size (or a bit size) is continually reduced. In recent years, with development of image sensors and compact camera modules (CCM), application and popularization of the barcode are accelerated.

A good barcode reading apparatus has to have enough resolution for providing a clear image to a barcode decoder. Moreover, the bard code reading apparatus is also required to have an enough depth of field for providing a suitable barcode detecting distance. However, as requirement for resolution becomes stringent, and meanwhile strictly limited by a lens number and fabrication cost, the conventional barcode reading apparatus has a dilemma in selecting the depth of field and the resolution, and is difficult to achieve a both-satisfactory design.

### SUMMARY

An embodiment of the disclosure provides a barcode reading apparatus adapted to detect a barcode. The barcode reading apparatus includes an imaging lens, an image sensor, and a barcode decoder. The imaging lens has a spherical aberration to extend a depth of field of the imaging lens. The imaging lens is configured to image the barcode onto the image sensor. The image sensor converts an image of the barcode into a barcode signal. The barcode decoder is configured to decode the barcode signal to obtain information represented by the barcode.

Another embodiment of the disclosure provides a barcode reading method, which includes following steps. A barcode is imaged onto an image sensor by an imaging lens, where the imaging lens has a spherical aberration to extend a depth of field of the imaging lens. An image of the barcode is converted into a barcode signal by the image sensor. Decoding is performed according to the barcode signal to obtain information represented by the barcode.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of a barcode reading apparatus according to an exemplary embodiment.

FIG. 2 is an implementation of an imaging lens of FIG. 1.

FIGS. 3A-3F are diagrams respectively illustrating modulation transfer functions (MTF) simulated when the image lens of FIG. 1 is replaced by a conventional lens and object distances are respectively 55 mm, 70 mm, 92 mm, 110 mm, 150 mm and 215 mm.

FIGS. 4A-4F are diagrams respectively illustrating point spread functions (PSF) simulated when the image lens of FIG. 1 is replaced by the conventional lens and object distances are respectively 55 mm, 70 mm, 92 mm, 110 mm, 150 mm and 215 mm.

FIG. 5 is a diagram illustrating a through-focus MTF simulated when the image lens of FIG. 1 is replaced by the conventional lens and a spatial frequency is 60 lp/mm.

FIGS. 6A-6F are diagrams respectively illustrating MTFs of the imaging lens of FIG. 1 simulated when object distances are respectively 55 mm, 70 mm, 92 mm, 110 mm, 150 mm and 215 mm.

FIGS. 7A-7F are diagrams respectively illustrating PSFs of the imaging lens of FIG. 1 simulated when object distances are respectively 55 mm, 70 mm, 92 mm, 110 mm, 150 mm and 215 mm.

FIG. 8 is a diagram illustrating a through-focus MTF of the image lens of FIG. 1 simulated when a spatial frequency is 60 lp/mm.

FIG. 9 is a flowchart illustrating a method for optimizing the imaging lens 110 of FIG. 1.

FIG. 10 is a schematic diagram of a barcode reading apparatus according to another exemplary embodiment.

FIG. 11 is a flowchart illustrating a barcode reading method according to an exemplary embodiment.

FIG. 12 is a schematic diagram of a barcode reading apparatus according to still another exemplary embodiment.

FIG. 13 is a test diagram applied to an image restoration filter of FIG. 12.

FIG. 14 is a three-dimensional diagram of filter parameters of the image restoration filter of FIG. 12.

FIG. 15 is diagram illustrating frequency responses of a horizontal MTF (i.e. MTFx) and a vertical MTF (i.e. MTFy) after the fast Fourier transformation (FFT) is performed to the filter parameters of FIG. 14.

FIG. 16 is a flowchart illustrating a barcode reading method according to another exemplary embodiment.

### DETAILED DESCRIPTION OF DISCLOSED EMBODIMENTS

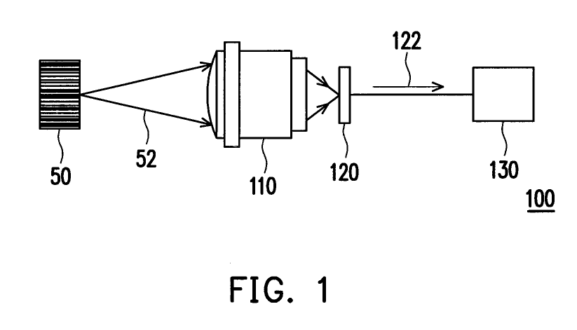

FIG. 1 is a schematic diagram of a barcode reading apparatus according to an exemplary embodiment. Referring to FIG. 1, the barcode reading apparatus 100 is adapted to detect a barcode 50. The barcode reading apparatus 100 includes an imaging lens 110, an image sensor 120, and a barcode decoder 130. The imaging lens 110 has a spherical aberration to extend a depth of field of the imaging lens 110. The imaging lens 110 is for imaging the barcode 50 onto the image sensor 120, and the image sensor 120 converts an image of the barcode 50 into a barcode signal 122. The barcode decoder 130 performs decoding according to the barcode signal 122 to obtain information represented by the barcode 50. In an embodiment, the barcode decoder 130 decodes the barcode signal 122 to obtain information represented by the barcode 50.

In detail, the imaging lens 110 converges an object light 52 emitted from the barcode 50 onto the image sensor 120 to image the barcode 50 onto the image sensor 120. In the present embodiment, the imaging lens 110 has an axial aberration, i.e. an aberration on an optical axis of the imaging lens 110, and such axial aberration includes at least one order of all orders of spherical aberration. In the present exemplary embodiment, the axial aberration includes a third order spherical aberration. For example, a wavefront of the object light 52 viewed from an exit pupil of the imaging lens 110 can be represented as:

$$W ( ρ ) = \frac{{r}_{max}^{2}}{2 {f}_{0}} {ρ}^{2} + ( \frac{- Δ z}{16 {( F \# )}^{2}} ) {ρ}^{4} + ( \frac{- Δ z}{24 {( F \# )}^{2}} ) ( \frac{- Δ z}{{f}_{0}} ) {ρ}^{6} + ( \frac{- Δ z}{32 {( F \# )}^{2}} ) {( \frac{- Δ z}{{f}_{0}} )}^{2} {ρ}^{8} + …$$

$$where$$

$$\frac{{r}_{max}^{2}}{2 {f}_{0}} {ρ}^{2}$$

is a wavefront of a perfect spherical wave generated in a perfect optical system (i.e. the imaging lens has no aberration), and

$$( \frac{- Δ z}{16 {( F \# )}^{2}} ) {ρ}^{4} + ( \frac{- Δ z}{24 {( F \# )}^{2}} ) ( \frac{- Δ z}{{f}_{0}} ) {ρ}^{6} + ( \frac{- Δ z}{32 {( F \# )}^{2}} ) {( \frac{- Δ z}{{f}_{0}} )}^{2} {ρ}^{8} + …$$

is a wavefront aberration of the imaging lens 110. In other words, the wavefront aberration W_{SA}(ρ) of the imaging lens 110 can be represented by a following equation:

$$\begin{matrix}{W}_{SA} ( ρ ) = ( \frac{- Δ z}{16 {( F \# )}^{2}} ) {ρ}^{4} + ( \frac{- Δ z}{24 {( F \# )}^{2}} ) ( \frac{- Δ z}{{f}_{0}} ) {ρ}^{6} + ( \frac{- Δ z}{32 {( F \# )}^{2}} ) {( \frac{- Δ z}{{f}_{0}} )}^{2} {ρ}^{8} + … \\ = {W}_{040} {ρ}^{4} + {W}_{060} {ρ}^{6} + {W}_{080} {ρ}^{8} + …\end{matrix}$$

where rₘₐₓ is a radius of the exit pupil of the imaging lens 110, f₀ is a paraxial focal length of the imaging lens 110, ρ is a normalized height of the exit pupil of the imaging lens 110, Δz is a designed depth of focus of the imaging lens 110, and W₀₄₀, W₀₆₀ and W₀₈₀ are respectively coefficients of the third, a fifth and a seventh order spherical aberrations. If in form of an infinite series, the wavefront aberration is equivalent to a representing method of each even order Seidel aberration:

$$W ( ρ ) = {\sum }_{n = 4 , 6 , 8 , …} ( \frac{Δ z}{4 {n ( F \# )}^{2}} ) {( - \frac{Δ z}{{f}_{0}} )}^{\frac{n - 4}{2}} {ρ}^{n}$$

where F# is an f-number of the imaging lens 110, and n relates to an order number of the spherical aberration of the imaging lens 110. In the present exemplary embodiment, an absolute value of the third order spherical aberration (i.e. W₀₄₀ρ⁴), for example, falls in a range of 0.25λ to 5.00λ, where λ is a wavelength of the object light 52.

In the present exemplary embodiment, the image sensor 120 is, for example, a charge coupled device (CCD) or a complementary metal oxide semiconductor (CMOS) sensor. Since the imaging lens 110 has the spherical aberration, the image of the barcode 50 imaged on the image sensor 120 is slightly blurred, though a blur degree of such image is less influenced by variation of an object distance (i.e. a distance between the barcode 50 and the imaging lens 110). In other words, compared to the conventional lens, the imaging lens 110 of the present exemplary embodiment has a larger depth of field and a larger depth of focus.

Although when the barcode 50 is imaged on the image sensor 120 through the imaging lens 110 having the spherical aberration, the image of the barcode 50 on the image sensor 120 is slightly blurred, the barcode signal converted from the image is within a tolerance range of the barcode decoder 130, and can be correctly decoded by the barcode decoder 130 to obtain the information represented by the barcode. Therefore, such slightly blurred image will not cause an error decoding, and since the depth of focus of the imaging lens 110 is increased, a range of the object distance suitable for correct decoding is enlarged. In this way, the barcode reading apparatus 100 of the present exemplary embodiment can improve utilization convenience, and can effectively mitigate the dilemma of the conventional barcode reading apparatus in selecting the depth of field or the resolution which causes inconvenient in utilization.

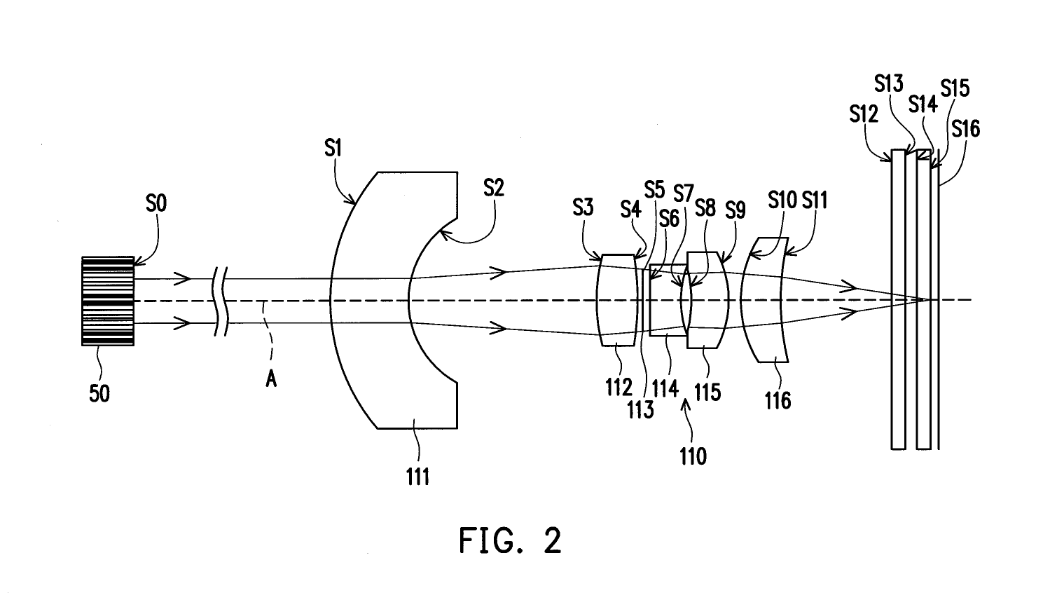

FIG. 2 is an implementation of an imaging lens of FIG. 1. Referring to FIG. 2, the imaging lens 110 of FIG. 2 is only an implementation of the imaging lens 110 of FIG. 1, which is not used to limit the disclosure. In other embodiments that are not illustrated, the imaging lens 110 of FIG. 1 can also use a lens generating the spherical aberration and having a different lens number and a different lens type, or can also use a lens having another optical device capable of generating the spherical aberration, and the another optical device capable of generating the spherical aberration is, for example, a phase mask, a diffractive optical device or a graded refractive index device.

In the present exemplary embodiment, the imaging lens 110 includes at least a circularly symmetric lens. For example, the circularly symmetric lens is circularly symmetric according to the optical axis of the circularly symmetric lens. In detail, in the present embodiment, the imaging lens 110 includes a first lens 111, a second lens 112, an aperture stop 113, a third lens 114, a fourth lens 115 and a fifth lens 116 sequentially arranged along a direction from the barcode 50 to the image sensor 120, and refractive powers of the first lens 111, the second lens 112, the third lens 114, the fourth lens 115 and the fifth lens 116 are sequentially negative, positive, negative, positive and positive. In detail, the first lens 111 is, for example, a convexo-concave lens with a convex surface facing to the barcode 50, the second lens 112 is, for example, a biconvex lens, the third lens 114 is, for example, a biconcave lens, the fourth lens 115 is, for example, a concavo-convex lens with a convex surface facing to the image sensor 120, and the fifth lens 116 is a convexo-concave lens with a convex surface facing to the barcode 50, where the first lens 111 and the second lens 112 are for example, aspheric lenses, and the third lens 114, the fourth lens 115 and the fifth lens 116 are, for example, spherical lenses.

An example of parameters of the imaging lens 110 is provided below. It should be noticed that data listed in following table one and table two are not used for limiting the disclosure, and those skilled in the art can suitably modify the parameters or settings after reading the disclosure, which is also within the scope of the disclosure.

TABLE ONE

| | Radius of | | Aperture | | |
|---|---|---|---|---|---|
| | curvature | Interval | radius | Material | |
| Surface | (mm) | (mm) | (mm) | type | Remark |
| S0 | Infinite | 92.000000 | | AIR | Barcode |
| S1 | 8.102900 | 2.500000 | 4.253200 | E48R | First lens |
| S2 | 3.220380 | 6.335912 | 2.660700 | AIR | |
| S3 | 4.731160 | 1.283950 | 1.491800 | S-LAH65 | Second lens |
| S4 | −13.541740 | 0.250000 | 1.215800 | AIR | |
| S5 | Infinite | 0.250000 | 1.006400 | AIR | Aperture |
| | | | | | stop |
| S6 | −496.694110 | 1.000000 | 1.053600 | S-TIH53 | Third lens |
| S7 | 3.843090 | 0.344632 | 1.175600 | AIR | |
| S8 | −6.218980 | 1.230728 | 1.200500 | S-LAH66 | Fourth lens |
| S9 | −3.753670 | 0.433905 | 1.593200 | AIR | |
| S10 | 4.125620 | 1.295873 | 2.048300 | BK7 | Fifth lens |
| S11 | 9.081760 | 4.000000 | 2.046900 | AIR | |
| S12 | Infinite | 0.550000 | 5.000000 | BK7 | Infrared |
| | | | | | filter |
| S13 | Infinite | 0.100000 | 5.000000 | AIR | |
| S14 | Infinite | 0.400000 | 5.000000 | BK7 | Cover glass |
| S15 | Infinite | 0.025000 | 5.000000 | AIR | |
| S16 | Infinite | | 5.000000 | | Sensing |
| | | | | | surface |

In the table one, the radius of curvature refers to a radius curvature of each surface (for example, surfaces S0-S15 of FIG. 2) at a place closed to an optical axis A of the imaging lens 110, and “infinite” represents that the surface is a plane. The interval refers to a straight-line distance along the optical axis A between two adjacent surfaces, for example, the interval of the surface S1 is the straight-line distance along the optical axis A between the surface S1 and the surface S2. The aperture radius refers to a vertical distance between an edge of each surface and the optical axis A. The material type refers to a type of a material between two adjacent surfaces. For example, the material type of the row of the surface S1 refers to a transparent material with a serial number of E48R between the surface S1 and the surface S2. Moreover, S-LAH65, S-TIH53, S-LAH66 and BK7 are all serial numbers of transparent materials. These material numbers are known or can be looked up by those skilled in the art, so that details of the materials are not described herein. Moreover, in the column of the material type, “AIR” represents air, i.e. none lens or other optical device is disposed therein. The radius of curvature, the thickness, the aperture radius and the material type of each lens in the remark column can refer to corresponding values of the radius of curvature, the interval, the aperture radius and the material type of the same row. Moreover, in the table one, the surfaces S1 and S2 are two surfaces of the first lens 111, the surfaces S3 and S4 are two surfaces of the second lens 112, the surface S5 is the aperture stop 113, the surfaces S6 and S7 are two surfaces of the third lens 114, the surfaces S8 and S9 are two surfaces of the fourth lens 115, and the surfaces S10 and S11 are two surfaces of the fifth lens 116. The surfaces S12 and S13 are two surfaces of an infrared filter 123 for blocking infrared, the surfaces S14 and S15 are two surfaces of a cover glass 124 of the image sensor 120, and the surface S16 is a sensing surface of the image sensor 120.

The above surface S1, S2 and S4 are even aspheric surfaces, which can be represented by a following equation:

$$Z = \frac{{cr}^{2}}{1 + \sqrt{1 - ( 1 + k ) {c}^{2} {r}^{2}}} + {A}_{2} {r}^{2} + {A}_{4} {r}^{4} + {A}_{6} {r}^{6} + {A}_{8} {r}^{8} + {A}_{10} {r}^{10} + …$$

where Z is a sag along a direction of the optical axis A, c is a spherical curvature, k is a conic constant, r is an aspheric height, i.e. a height from a lens center to a lens edge, and A₂, A₄, A₆, A₈ and A₁₀ are aspheric coefficients, and in the present exemplary embodiment, the coefficients A₂ of the surfaces S1, S2 and S4 are 0. In the following table two, aspheric coefficients of the surfaces S1, S2 and S4 are listed. Moreover, the surfaces S0, S3, S5-S15 are spherical surfaces, where the spherical surfaces S5, S12-S15 include a plane with an infinite radius of curvature.

TABLE TWO

| Aspher- | Conic | | | | |
|---|---|---|---|---|---|
| ic | con- | | | | |
| para- | stant | Coefficient | Coefficient | Coefficient | Coefficient |
| meter | k | A₄ | A₆ | A₈ | A₁₀ |
| S1 | 0 | 2.1157e−03 | −4.7485e−05 | 1.1360e−07 | 0 |
| S2 | 0 | 6.1403e−03 | −8.6904e−05 | −7.1132e−06 | 0 |
| S4 | 0 | −4.8830e−04 | 4.8406e−04 | −6.5991e−05 | 7.2235e−06 |

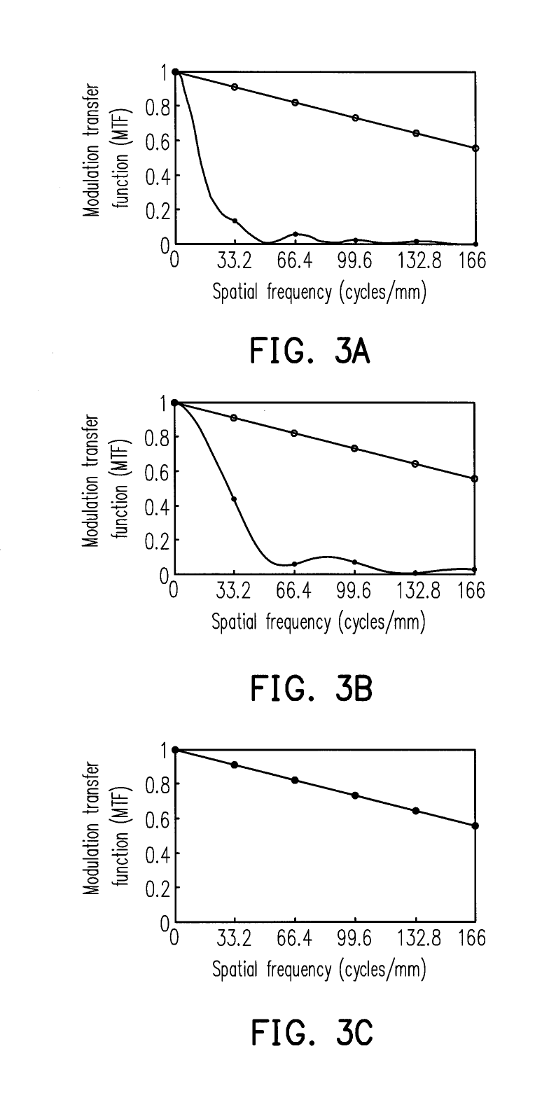

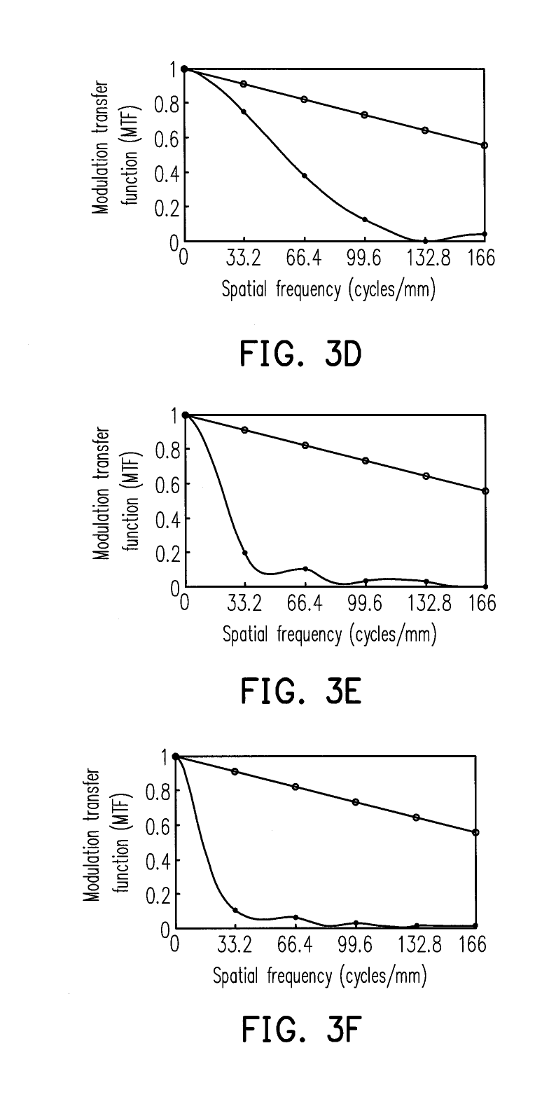

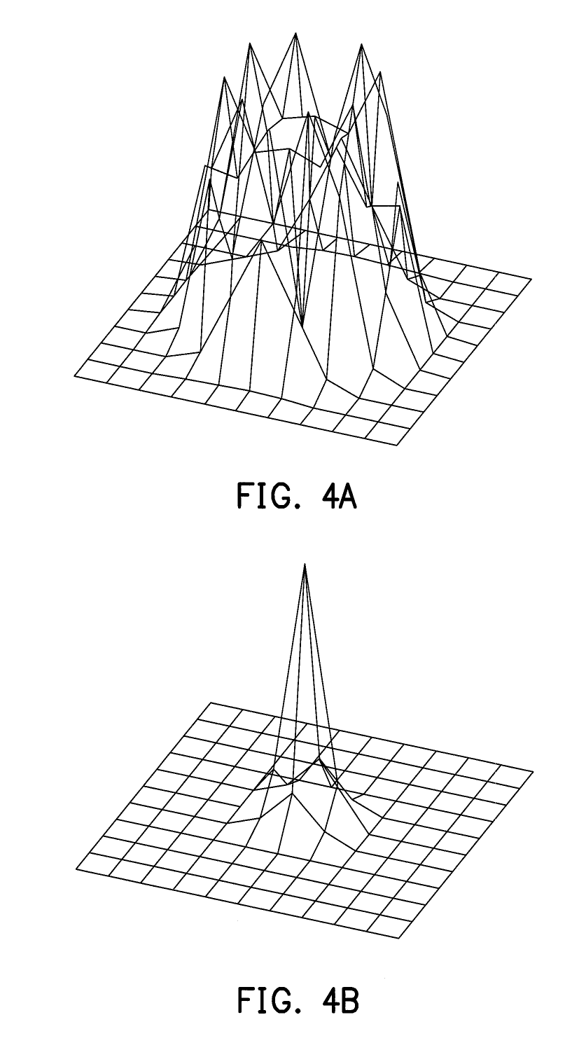

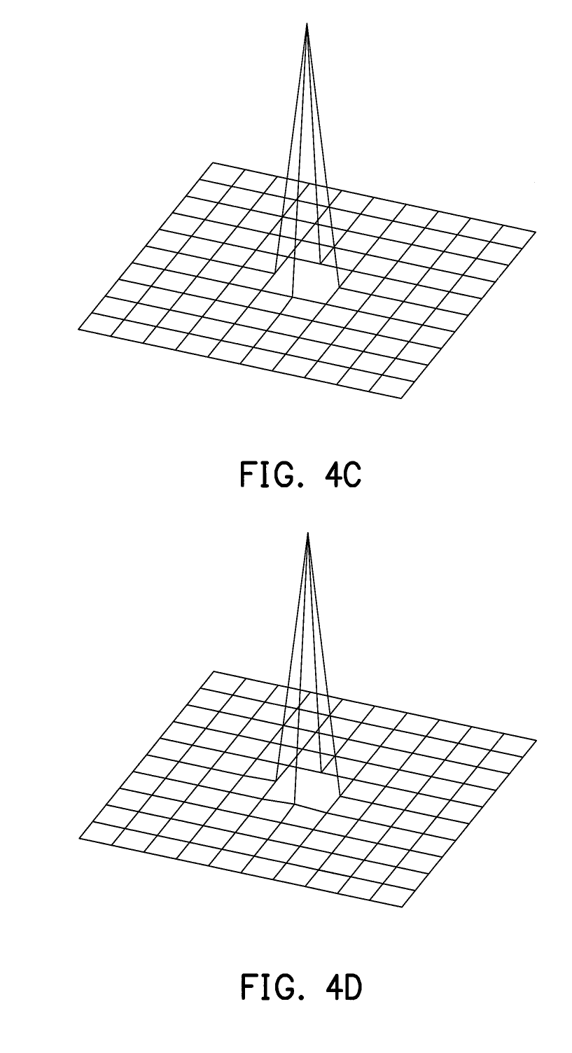

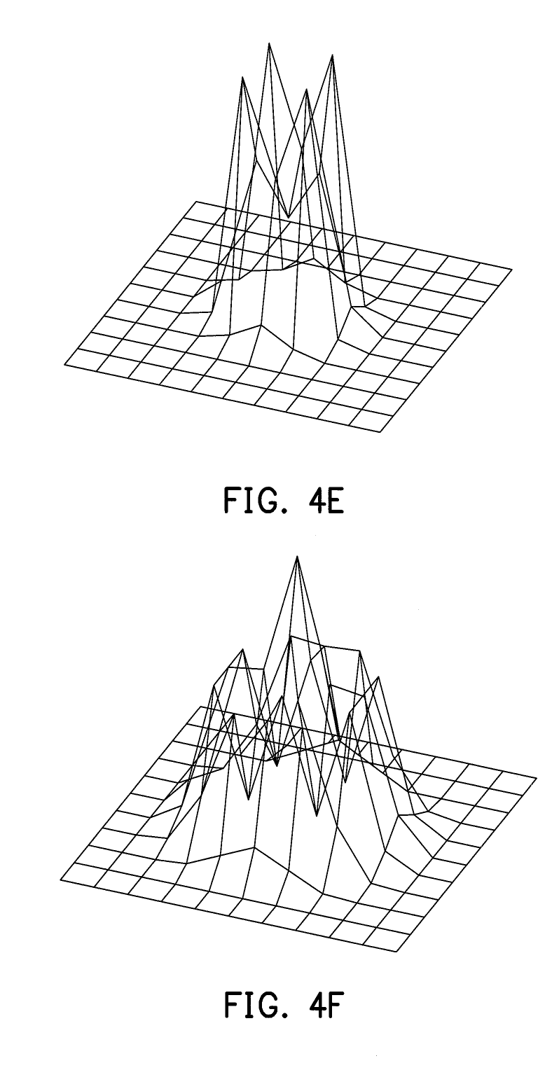

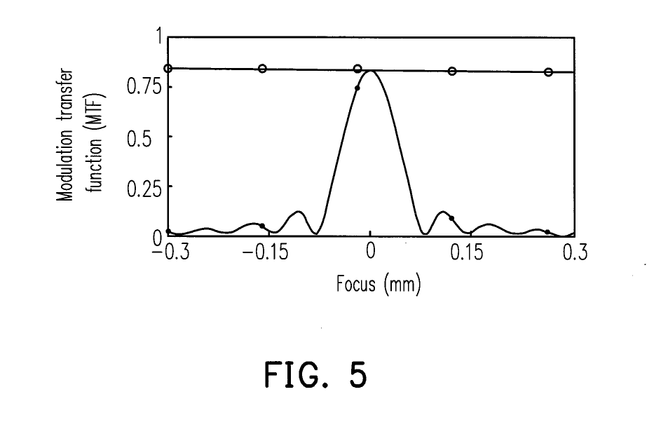

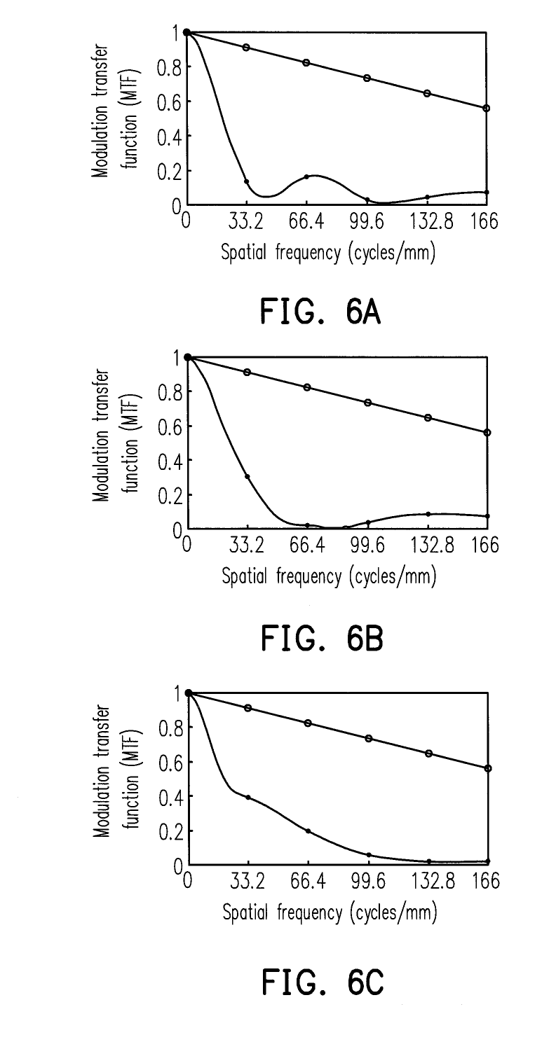

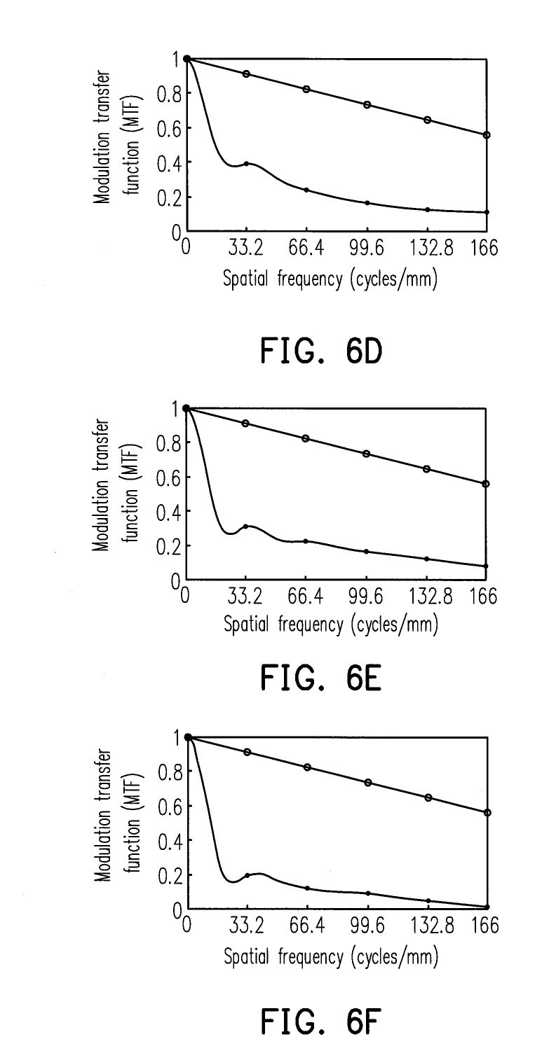

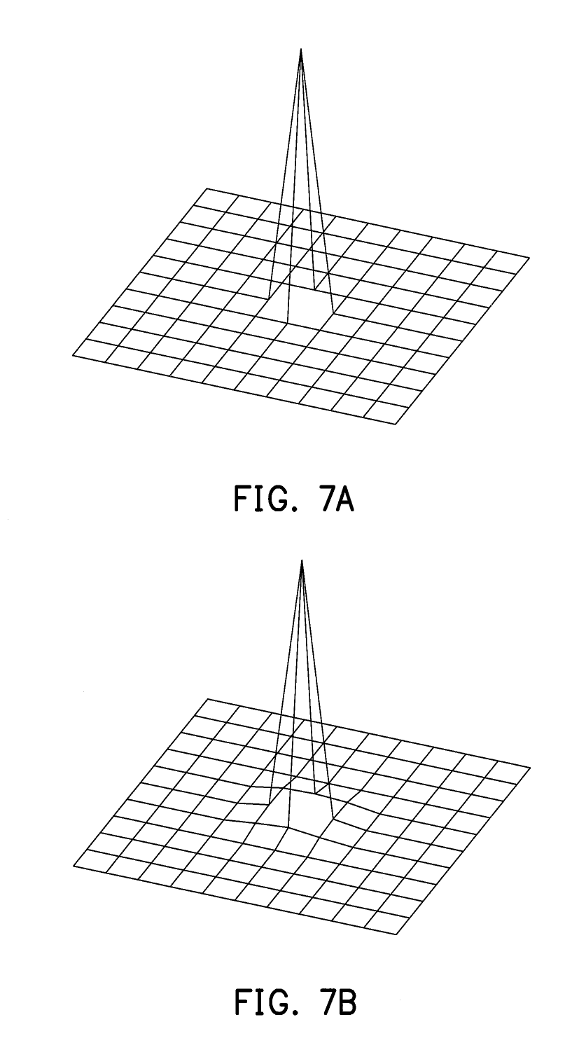

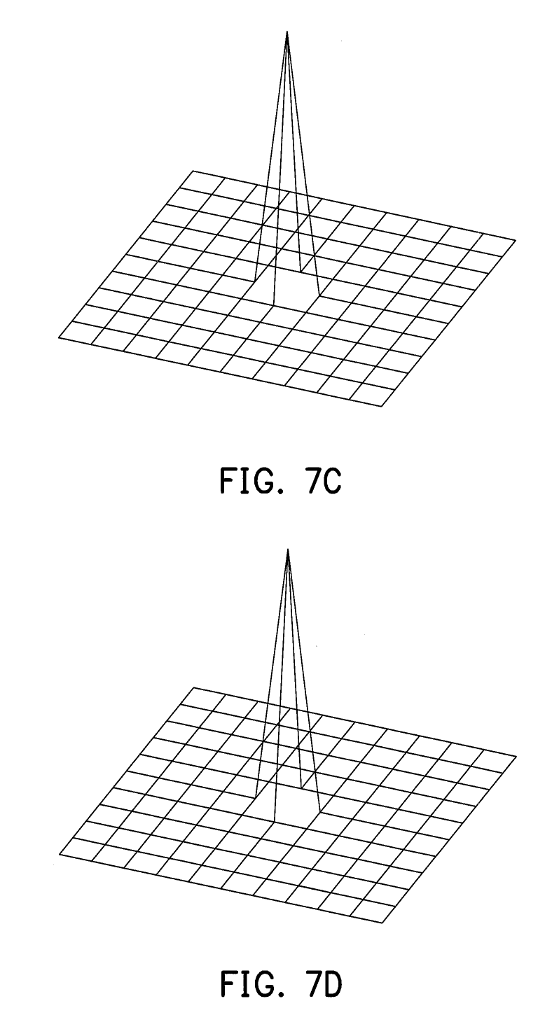

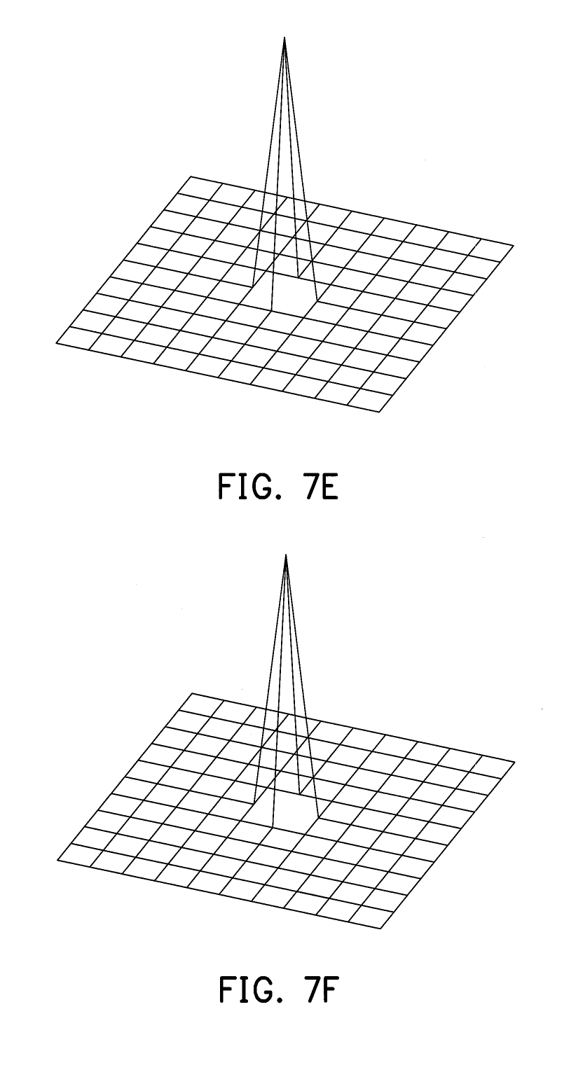

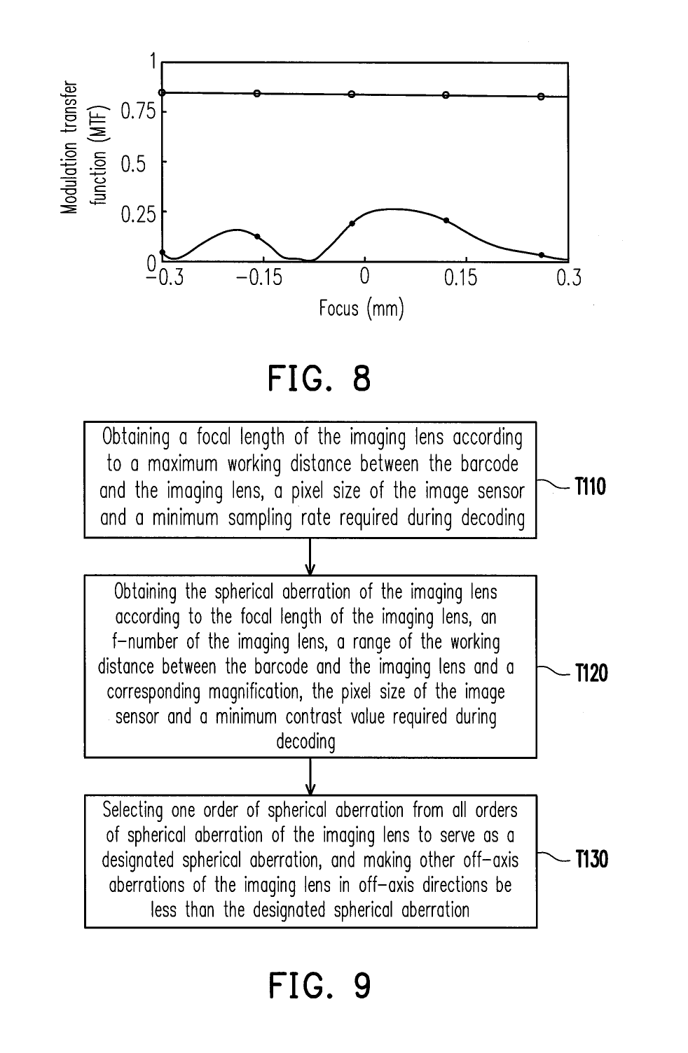

FIGS. 3A-3F are diagrams respectively illustrating modulation transfer functions (MTF) simulated when the image lens of FIG. 1 is replaced by a conventional lens and object distances are respectively 55 mm, 70 mm, 92 mm, 110 mm, 150 mm and 215 mm. FIGS. 4A-4F are diagrams respectively illustrating point spread functions (PSF) simulated when the image lens of FIG. 1 is replaced by the conventional lens and object distances are respectively 55 mm, 70 mm, 92 mm, 110 mm, 150 mm and 215 mm. FIG. 5 is a diagram illustrating a through-focus MTF simulated when the image lens of FIG. 1 is replaced by the conventional lens and a spatial frequency is 60 lp/mm. FIGS. 6A-6F are diagrams respectively illustrating MTFs of the imaging lens of FIG. 1 simulated when object distances are respectively 55 mm, 70 mm, 92 mm, 110 mm, 150 mm and 215 mm. FIGS. 7A-7F are diagrams respectively illustrating PSFs of the imaging lens of FIG. 1 simulated when object distances are respectively 55 mm, 70 mm, 92 mm, 110 mm, 150 mm and 215 mm. FIG. 8 is a diagram illustrating a through-focus MTF of the image lens of FIG. 1 simulated when a spatial frequency is 60 lp/mm. In FIGS. 4A-4F and FIGS. 7A-7F, coordinates of the plane where the rectangular grids are located represent actual space coordinates, and a vertical axis (which is along an up and down direction in figures) of the figures represents a light intensity, where the upper place of the vertical axis is, the greater the light intensity is. By comparing the optical simulation curves obtained according to the conventional lens (for example, the MTF distribution diagrams of FIGS. 3A-3F, the PSF distribution diagrams of FIGS. 4A-4F and the through-focus MTF distribution diagram of FIG. 5) with the optical simulation curves obtained according to the imaging lens 110 of the present exemplary embodiment (FIGS. 6A-6F, FIGS. 7A-7F and FIG. 8), it is known that the barcode reading apparatus 100 and the imaging lens 110 indeed have greater depth of field and greater depth of focus.

In detail, in the present exemplary embodiment, the imaging lens 110 can serve as a coding lens. Compared to the conventional lens, the MTFs and the PSFs of the imaging lens 110 of the present exemplary embodiment have a high degree of similarity, especially when the object distance is within a range of 92 mm to 215 mm, so that the images of the barcode captured within such object distance range have similar degree of blur. Moreover, the MTF of the imaging lens 110 has none zero point within a frequency range of 0-166 lp/mm (i.e. cycles/mm) in case that the object distance is within 92 mm-215 mm, so that information loss within the required frequency range is avoided, which avails a post decoding operation. Regarding image capturing of the barcode 50, demanding of a resolution of the image lens 110 relates to the object distance, a barcode size and a pixel size of the image sensor 120, the object distance determines a magnification of the lens, and a minimum bar size of the barcode 50 and the sensor pixel size determine a sampling rate, and the above relation can be represented by a following equation:

$$Sampling rate = \frac{minimum bar size \times magnification}{Sensor pixel size}$$

where the sampling rate represents the number of pixel(s) occupied by one bar, and the higher the sampling rate is, the lower frequency of the input image signal is, which is not liable to be influenced by noise or aliasing. Taking the sensor pixel size of 6×6 μm² as an example, a Nyquist frequency thereof is 83 lp/mm. When the sampling rate is equal to 1, it represents the frequency of the image signal is 83 lp/mm. In other words, when the sampling rate is equal to 1, it represents the frequency of the image signal is 83/2=41.5 lp/mm. According to the above equation, two conclusions can be deduced as follows. First, the barcode placed in a short distance has relatively large lens magnification, so that the sampling rate thereof is relatively great, and the signal frequency is relatively low, while the barcode placed in a long distance has a smaller magnification, so that the sampling rate is relatively small, and the signal frequency is relatively high. Second, relatively large bar size may lead to relatively great sampling rate, and the signal frequency is relatively low, and conversely relatively small sampling rate is obtained and the signal frequency is relatively high.

In the present exemplary embodiment, design of the imaging lens 110 is complied with the above conclusions, and when the barcode 50 is in a long object distance (for example, the object distance >92 mm), the MTF is relatively high for providing enough contrast for the barcode digital image. When the barcode 50 is placed in a short object distance (for example, the object distance <92 mm), although the MTF generates a zero point, a certain MTF amplitude is still maintained at low frequency (about 33 lp/mm), so that the advantage of the magnification can be used to maintain adequate image quality. Therefore, according to the required barcode specification and the required suitable object distance range, and the pixel size of the image sensor and the magnification of the imaging lens 110, sampling rates of the system under different object distance conditions are defined, and according to the requirement of the used barcode decoder for the sampling rate, the MTF characteristic maintained by different spatial frequencies is obtained to serve as a merit function of a lens design. Then, the provided spherical aberration equation is used to optimize the imaging lens 110 to obtain the imaging lens having a depth of field expansion capability.

FIG. 9 is a flowchart illustrating a method for optimizing the imaging lens 110 of FIG. 1. Referring to FIG. 9, the method for optimizing the imaging lens 110 includes following steps. First, a step T110 is executed that a focal length of the imaging lens 110 is obtained according to a maximum working distance between the barcode 50 and the imaging lens 110, the pixel size of the image sensor 120 and the minimum sampling rate required by the barcode decoder 130. Then, a step T120 is executed that the spherical aberration of the imaging lens 110 is obtained according to the focal length of the imaging lens 110, the f-number of the imaging lens 110, a range of the working distance between the barcode 50 and the imaging lens 110 and the corresponding magnification, the pixel size of the image sensor 120 and a minimum contrast value required by the barcode decoder 130. Then, a step T130 is executed that one order of spherical aberration (for example, the third order spherical aberration) is selected from all orders of spherical aberration to serve as a designated spherical aberration, and off-axis aberrations of the imaging lens 110 in the off-axis directions are made to be less than the designated spherical aberration (i.e. the third order spherical aberration). In this way, optimization of the imaging lens 110 is completed.

In a following table three, comparison results of the conventional lens and the imaging lens 110 of the present exemplary embodiment are listed, in which three bar sizes of 0.254 mm (matrix code), 0.33 mm (JAN13) and 0.5 mm (code39) are tested, and a determination success rate of 50% is taken as a threshold. According to the table three, it is known that an applicable distance of the imaging lens 110 is obviously superior to that of the conventional lens, and a theoretical limitation of the sampling rate >1 at the rightmost column is a sampling rate limitation deduced according to the sensor pixel size of 6×6 μm² and the magnifications (shown in a following table four). Therefore, it is known that although the image obtained by the imaging lens 110 of the present exemplary embodiment is slightly blurred, it is insensitive to the object distance variation, so that a stable imaging quality can be provided.

TABLE THREE
Applicable distance (mm)

| | | Imaging lens | Theoretical limitation |
|---|---|---|---|
| Bar size | Conventional lens | 110 | of sampling rate >1 |
| 0.254 mm | 110 | 55-120 | 55-215 |
| 0.33 mm | 55-205 | 55-245 | 55-280 |
| 0.5 mm | 55-295 | 55-325 | 70-400 |

TABLE FOUR

| Object distance (mm) | Magnification |
|---|---|
| 55 | 0.087897 |
| 70 | 0.070146 |
| 85 | 0.057912 |
| 92 | 0.054116 |
| 110 | 0.045592 |
| 150 | 0.033771 |
| 215 | 0.023760 |
| 250 | 0.020490 |
| 300 | 0.017123 |
| 350 | 0.014706 |
| 400 | 0.012887 |

In the present exemplary embodiment, a distance between the imaging lens 110 and the image sensor 120 is determined according to the contrast of the image sensed by the image sensor 120, so as to focus the imaging lens 110. For example, the distance between the imaging lens 110 and the image sensor 120 can be varied first to obtain image contrasts detected under different distances. Then, the imaging lens 110 and the image sensor 120 are fixed in a distance corresponding to a maximum contrast, or fixed in a distance corresponding to the contrasts over a certain degree according to an actual requirement, where a mechanism is used to fix the imaging lens 110 and the image sensor 120.

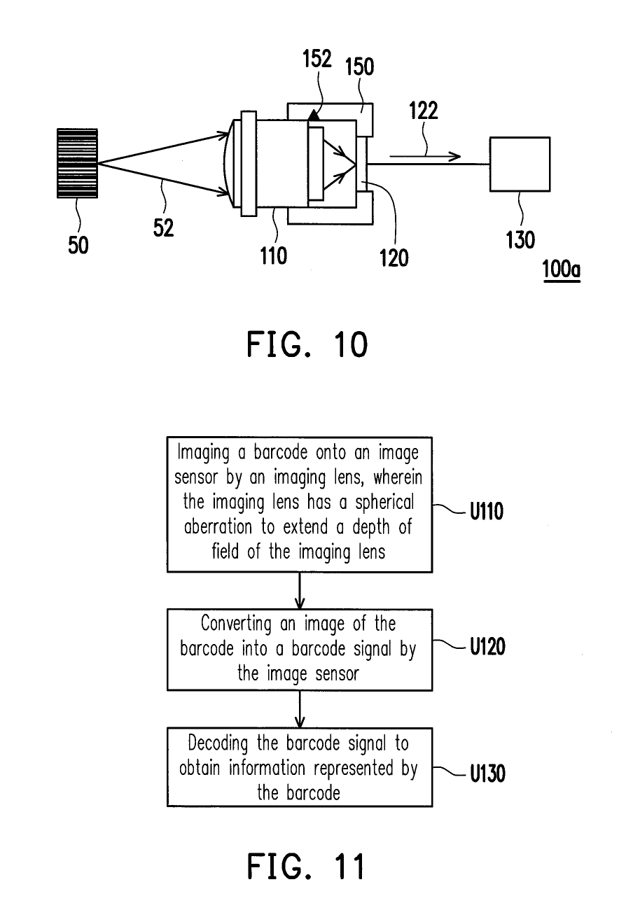

FIG. 10 is a schematic diagram of a barcode reading apparatus according to another exemplary embodiment. Referring to FIG. 10, the barcode reading apparatus 100a is similar to the barcode reading apparatus 100 of FIG. 1, and a difference therebetween lies in focusing. In the present exemplary embodiment, the barcode reading apparatus 100a further includes a support mechanism 150, which supports the imaging lens 110 and the image sensor 120. In the present exemplary embodiment, a focus distance of the imaging lens 110 has been obtained through optical simulation, calculation or experiment, so that a reference mark 152 can be marked on the support mechanism 150, and a distance between the imaging lens 110 and the image sensor 120 is determined according to the reference mark 152 to focus the imaging lens 110. For example, a certain part of the imaging lens 110 can be aligned to the reference mark 152, or a certain specific distance is maintained between the imaging lens 110, the image sensor 120 and the reference mark 152. When the imaging lens 110 and the image sensor 120 are in specific positions relative to the reference mark 152, the distance between the imaging lens 110 and the image sensor 120 is complied with the distance obtained according to the optical simulation, calculation or experiment, so as to focus the imaging lens 110.

FIG. 11 is a flowchart illustrating a barcode reading method according to an exemplary embodiment. Referring to FIG. 11, the barcode reading method of the present exemplary embodiment can be applied to the barcode reading apparatus 100 of FIG. 1 or the barcode reading apparatus 100a of FIG. 10. The barcode reading method includes following steps. First, a step U110 is executed that the barcode 50 is imaged onto the image sensor 120 by the imaging lens 110, where the imaging lens 110 has a spherical aberration to extend a depth of field of the imaging lens 110. Moreover, other details of the imaging lens 110 and the image sensor 120 are as that described in the aforementioned exemplary embodiment, which are not repeated herein. Then, a step U120 is executed that an image of the barcode 50 is converted into a barcode signal 122 by the image sensor 120. Then, a step U130 is executed that decoding is performed according to the barcode signal 122 to obtain information represented by the barcode 50, for example, the barcode decoder 130 is configured to decode. In the step U130, image pre-processing can be first performed to the digital image sensed by the image sensor 120, for example, at least one of gamma calibration, sharpening, defect compensation and bias cancellation is performed, and then the pre-processed digital image is decoded to obtain information represented by the barcode 50 by the barcode decoder 130.

Other details of the barcode reading method of the present exemplary embodiment may refer to the aforementioned exemplary embodiment, and a design method of the imaging lens 110 may refer to the optimizing method of FIG. 9, which are not repeated herein. Since the barcode reading method of the present exemplary embodiment uses the imaging lens 110 having the spherical aberration to extend the depth of field, according to the barcode reading method of the present exemplary embodiment, information of the barcode can be correctly read within a large range of the object distance, which may increase utilization convenience.

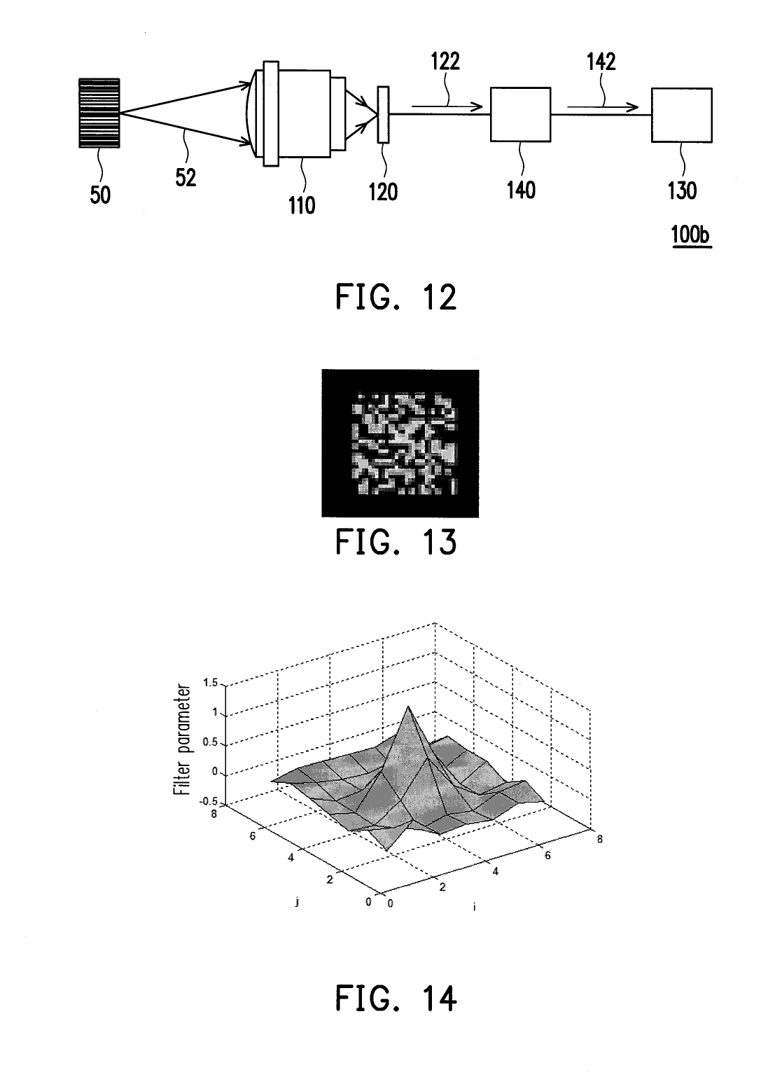

FIG. 12 is a schematic diagram of a barcode reading apparatus according to still another exemplary embodiment. Referring to FIG. 12, the barcode reading apparatus 100b in this embodiment is similar to the barcode reading apparatus 100 of FIG. 1, and differences there between are as follows. The barcode reading apparatus 100b of the present exemplary embodiment further includes an image restoration filter 140, which is used for calculating and converting the barcode signal 122 output from the image sensor 120 into a restored signal 142, where the restored signal 142 is more close to the barcode 50 than the barcode signal 122 is, and the barcode decoder 130 decodes the restored signal 142 to obtain the information represented by the barcode 50.

In the present exemplary embodiment, the image restoration filter 140 is, for example, a minimum mean square error (MMSE) filter. However, in other embodiments, the image restoration filter 140 can also be a Wiener filter, an iterative least mean square (ILMS) filter, a maximum likelihood (ML) filter, a maximum entropy (ME) filter or other suitable filters.

Regarding a space domain calculation, the image restoration filter 140 can process the digital image by a convolution operation, for example, a mask operation can be used to complete the convolution operation. For example, a filter parameter of the image restoration filter 140 can be suitably transposed in advance, and an operation thereof is shown in a following equation:

$$\hat{I} ( i , j ) = {\sum }_{k = 1}^{M} {\sum }_{l = 1}^{N} B ( i + k , j + l ) W ( k , l ) \qquad ( 1 )$$

where, Î represents a restored digital image, B is a digital image captured by the image sensor, and W is the filter parameter. In the above equation, variables in the brackets (for example, i, j) are row and column indexes of the digital image, and M and N are dimensions of the image restoration filter 140. The filter parameters can be calculated according to a Wiener filtering method, a MMSE filtering method, an ILMS filtering method, a ML filtering method or a ME filtering method, and the MMSE filtering method is taken as an example for description. As the name implies, the MMSE filtering method is to find a set of the filter parameters to minimize a following performance index J:

J=E{(I(i,j)−\hat{I}(i,j))²}

where I is a target digital image, i.e. an ideal image that is not influenced by the lens set. Therefore, calculation of the filter parameters is required to satisfy following conditions:

$$\begin{matrix}W = ArgMin E \{ {( I ( i , j ) - \hat{I} ( i , j ) )}^{2} \} \\ = {ArgMin}_{W} E \{ {( I ( i , j ) - {\sum }_{k = 1}^{M} {\sum }_{l = 1}^{N} B ( i + k , j + l ) W ( k , l ) )}^{2} \}\end{matrix}$$

where the function ArgMin refers to generate a W, and E is the minimum under the W. When a set of the filter parameters is complied with the above equation, the processed digital image Î is quite similar to the ideal image I, or the processed digital image Î and the ideal image I have the minimum mean square error. Regarding a frequency response, since the image restoration filter is used to compensate image distortion or defects caused by the imaging lens 110 and the image sensor 120, the image restoration filter is generally used to increase amplitude of a low frequency MTF in the channel. Based on such theory, information of the PSF provided by optical design software can be used to calculate the filter parameters, or the filter parameters can be designed by capturing a standard test chart (for example, ISO12233 and a dot chart), a portrait image (for example, Lena), a view image or even a barcode image.

In the present exemplary embodiment, the parameters of the image restoration filter 140 are obtained by using the image sensor 120 to sense an image of a test chart through the imaging lens 110, and calculating the image of the test chart. The test chart may have a regular arrangement characteristic, grid lines, geometric figures or a random distribution characteristic, or have any combination of the above characteristics and patterns.

For example, in order to obtain the filter designs of the whole imaging system for the images having various frequency characteristics, a test chart (i.e. the target digital image) of FIG. 13 is used to calculate the filter parameters, and the test chart is mainly composed of figures having the pseudo random data characteristic. The filter parameters calculated according to the MMSE method are shown in a following table five.

TABLE FIVE

| | | | | | | |
|---|---|---|---|---|---|---|
| −0.1069 | 0.2776 | −0.0969 | −0.0648 | −0.1279 | 0.0206 | −0.0846 |
| 0.0529 | −0.0400 | −0.2058 | −0.0855 | −0.1564 | 0.0299 | 0.0742 |
| −0.1477 | −0.1900 | 0.1025 | 0.6919 | 0.0871 | −0.2126 | −0.1315 |
| −0.0490 | −0.1594 | 0.4087 | 1.3742 | 0.4332 | −0.2068 | 0.0501 |
| 0.0409 | −0.1363 | −0.0978 | 0.2158 | −0.0912 | −0.1774 | 0.0488 |
| 0.1126 | −0.0165 | −0.1046 | −0.1347 | −0.1929 | 0.0113 | 0.0936 |
| −0.0499 | 0.0388 | 0.0178 | 0.0027 | −0.0147 | 0.1315 | −0.2353 |

In the present exemplary embodiment, a 7×7 filter mask is designed, and during an actual application, the mask size can be adjusted according to a calculation load of a digital circuit or a central processing unit (CPU), for example, 5×5 or 4×4. Moreover, a singular value decomposition (SVD) method can be used for row-column decoupling, so as to simplify a structure of the image restoration filter 140, or a symmetric characteristic of the PSF of the coding lens (i.e. the imaging lens 110) is used to simplify an operation structure.

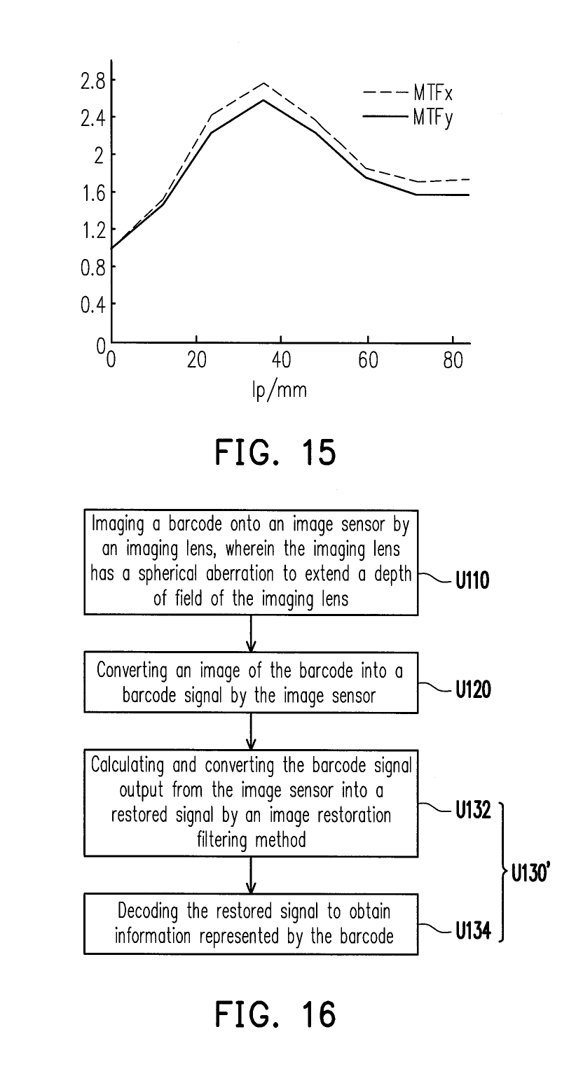

FIG. 14 is a three-dimensional diagram of the filter parameters of the image restoration filter of FIG. 12. Referring to FIG. 12 and FIG. 14, the fast Fourier transformation (FFT) is performed to such set of the filter parameters to obtain frequency responses of a horizontal MTF (i.e. MTFx) and a vertical MTF (i.e. MTFy) to form FIG. 15. According to FIG. 15, it is obvious that such set of the filter parameters mainly increase the MTF of 20-60 lp/mm.

In the present exemplary embodiment, the digital image is processed according to the above equation (1) in collaboration with the filter parameters of the table five. A following table six lists a comparison result of barcode decoding performances before and after the image restoration filter 140 is added, in which three bar sizes of 0.254 mm (matrix code), 0.33 mm (JAN13) and 0.5 mm (code 39) are tested, and a determination success rate of 50% is taken as a threshold.

TABLE SIX
Applicable distance (mm)

| | | Embodiment | Embodiment | Theoretical |
|---|---|---|---|---|
| | Conventional | of | of | limitation of |
| Bar size | lens | FIG. 1 | FIG. 12 | sampling rate >1 |
| 0.254 mm | 110 | 55-120 | 55-140 | 55-215 |
| 0.33 mm | 55-205 | 55-245 | 55-255 | 55-280 |
| 0.5 mm | 55-295 | 55-325 | 55-355 | 70-400 |

According to the table six, it is known that by using the image restoration filter, the detecting distance can be further extended to about 10-30 mm compared to the embodiment of FIG. 1. According to the experiment result, it is known that the image restoration filter 140 can indeed mitigate the image blur caused by the imaging lens 110 (i.e. the coding lens), so that image clarity and contrast can be effectively improved without causing image artefact or ringing or amplifying image noise, and correctness of barcode determination is improved, and the detecting distance (i.e. the object distance) is extended.

In the present embodiment, the distance between the imaging lens 110 and the image sensor 120 is determined according to a contrast of an image represented by the restored signal 142 calculated by the image restoration filter 140, so as to focus the imaging lens 110. For example, the distance between the imaging lens 110 and the image sensor 120 can be varied first to obtain images detected under different distances, and the image restoration filter 140 restores these images into a plurality of restored images. Then, the imaging lens 110 and the image sensor 120 are fixed in a distance corresponding to the restored image having a maximum contrast, or fixed in a distance corresponding to the restoring image having a contrast over a certain degree according to an actual requirement, where a mechanism is used to fix the imaging lens 110 and the image sensor 120. However, in another embodiment, the support mechanism 150 of FIG. 10 and the reference mark 152 can be used to focus the barcode reading apparatus 100b.

FIG. 16 is a flowchart illustrating a barcode reading method according to another exemplary embodiment. Referring to FIG. 16, the barcode reading method of the present exemplary embodiment can be applied to the barcode reading apparatus 100b of FIG. 12. The barcode reading method of the present exemplary embodiment is similar to the barcode reading method of FIG. 11, and a difference therebetween lies in the step U130 and a step U130′. In the barcode reading method of the present exemplary embodiment, the step of decoding the barcode signal (i.e. the step U130′) includes following steps. First, a step U132 is executed that the barcode signal 122 output from the image sensor 120 is calculated and converted into the restored signal 142 by an image restoration filtering method, where the restored signal 142 is more close to the barcode 50 than the barcode signal 122 is. In the present exemplary embodiment, the image restoration filter 140 is used to restore the barcode signal 122 into the restored signal 142, and other details can refer to the exemplary embodiment of FIG. 12, which are not repeated therein. Then, a step U134 is executed that the restored signal 142 is decoded to obtain the information represented by the barcode 50. In the present exemplary embodiment, the barcode decoder 130 is used to decode the restored signal 142 to obtain the information represented by the barcode 50, and other details can refer to the exemplary embodiment of FIG. 12, which are not repeated therein.

Moreover, in the step U134, image pre-processing can be first performed to the restored signal restored by the image restoration filter 140 (i.e. the image pre-processing is performed to the restoring images restored by the image restoration filter 140), for example, at least one of gamma calibration, sharpening, defect compensation and bias cancellation is performed, and then the barcode decoder 130 is used to decode the pre-processed digital image to obtain the information represented by the barcode 50.

The exemplary embodiment of FIG. 12 can be referred for other details of the barcode reading method, and the optimizing method of FIG. 9 can be referred for lens design, which are not repeated therein. Since the barcode reading method of the present exemplary embodiment uses the imaging lens 110 having the spherical aberration to extend the depth of field, and uses the image restoration filtering method to further extend the depth of field, the barcode reading method of the present exemplary embodiment can correctly read the information of the barcode under a larger range of the object distance, so as to increase utilization convenience.

In summary, in the barcode reading apparatus and the barcode reading method according to the embodiments of the disclosure, since the imaging lens having the spherical aberration is used to extend the depth of field, the barcode can be correctly read under a larger range of the object distance, so as to increase utilization convenience for barcode reading. In other words, the barcode reading apparatus and the barcode reading method according to the embodiments of the disclosure can effectively mitigate the dilemma of the conventional barcode reading apparatus and method in selecting the depth of field and the image decoding capability that causes utilization inconvenience.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A barcode reading apparatus, adapted to detect a barcode, the barcode reading apparatus comprising:
an imaging lens, having a spherical aberration to extend a depth of field of the imaging lens;
an image sensor, wherein the imaging lens is for imaging the barcode onto the image sensor, and the image sensor converts an image of the barcode into a barcode signal; and
a barcode decoder, configured to decode the barcode signal to obtain information represented by the barcode.

2. The barcode reading apparatus as claimed in claim 1, wherein the spherical aberration comprises a third order spherical aberration.

3. The barcode reading apparatus as claimed in claim 2, wherein an absolute value of the third order spherical aberration falls in a range of 0.25λ to 5.00λ.

4. The barcode reading apparatus as claimed in claim 1, wherein the imaging lens comprises at least one circularly symmetric lens.

5. The barcode reading apparatus as claimed in claim 1, further comprising an image restoration filter configured to calculate and convert the barcode signal output from the image sensor into a restored signal and the barcode decoder decodes the restored signal to obtain information represented by the barcode.

6. The barcode reading apparatus as claimed in claim 5, wherein the image restoration filter is a Wiener filter, a minimum mean square error (MMSE) filter, an iterative least mean square (ILMS) filter, a maximum likelihood (ML) filter, or a maximum entropy (ME) filter.

7. The barcode reading apparatus as claimed in claim 5, wherein a distance between the imaging lens and the image sensor is determined according to a contrast of an image represented by the restored signal calculated by the image restoration filter, so as to focus the imaging lens.

8. The barcode reading apparatus as claimed in claim 1, further comprising a support mechanism for supporting the imaging lens and the image sensor, wherein the support mechanism has a reference mark, and a distance between the imaging lens and the image sensor is determined according to the reference mark, so as to focus the imaging lens.

9. The barcode reading apparatus as claimed in claim 1, wherein a distance between the imaging lens and the image sensor is determined according to a contrast of an image sensed by the image sensor, so as to focus the imaging lens.

10. A barcode reading method, comprising:
imaging a barcode onto an image sensor by an imaging lens, wherein the imaging lens has at least one order of spherical aberration to extend a depth of field of the imaging lens;
converting an image of the barcode into a barcode signal by the image sensor; and
decoding the barcode signal to obtain information represented by the barcode.

11. The barcode reading method as claimed in claim 10, wherein the at least one order of spherical aberration comprises a third order spherical aberration.

12. The barcode reading method as claimed in claim 11, wherein an absolute value of the third order spherical aberration falls in a range of 0.25λ to 5.00λ.

13. The barcode reading method as claimed in claim 10, wherein the imaging lens comprises at least one circularly symmetric lens.

14. The barcode reading method as claimed in claim 10, wherein the step of decoding the barcode signal comprises:
calculating and converting the barcode signal output from the image sensor into a restored signal by an image restoration filtering method, wherein the restored signal is more close to the barcode than the barcode signal is; and
decoding the restored signal to obtain information represented by the barcode.

15. The barcode reading method as claimed in claim 14, wherein the image restoration filtering method is a Wiener filtering method, a minimum mean square error (MMSE) filtering method, an iterative least mean square (ILMS) filtering method, a maximum likelihood (ML) filtering method, or a maximum entropy (ME) filtering method.

16. The barcode reading method as claimed in claim 14, wherein an operation equation of the image restoration filtering method is obtained by using the image sensor to sense an imaging of a test chart through the imaging lens and calculating the imaging of the test chart.

17. The barcode reading method as claimed in claim 16, wherein the test chart has a regular arrangement characteristic, grid lines, geometric figures or a random distribution characteristic, or a combination thereof.

18. The barcode reading method as claimed in claim 16, wherein a distance between the imaging lens and the image sensor is determined according to a contrast of an image represented by the restored signal calculated by the image restoration filter, so as to focus the imaging lens.

19. The barcode reading method as claimed in claim 10, wherein a distance between the imaging lens and the image sensor is determined according to a reference mark on a support mechanism, so as to focus the imaging lens.

20. The barcode reading method as claimed in claim 10, wherein a distance between the imaging lens and the image sensor is determined according to a contrast of an image sensed by the image sensor, so as to focus the imaging lens.

21. The barcode reading method as claimed in claim 10, wherein a design of the imaging lens comprises:
obtaining a focal length of the imaging lens according to a maximum working distance between the barcode and the imaging lens, a pixel size of the image sensor and a minimum sampling rate required during decoding;
obtaining the spherical aberration of the imaging lens according to the focal length of the imaging lens, an f-number of the imaging lens, a range of the working distance between the barcode and the imaging lens and a corresponding magnification, the pixel size of the image sensor and a minimum contrast value required during decoding; and
selecting one order of spherical aberration of the imaging lens to serve as a designated spherical aberration, and making off-axis aberrations of the imaging lens in off-axis directions be less than the designated spherical aberration.

22. A barcode reading apparatus, adapted to detect a barcode, the barcode reading apparatus comprising:
an imaging lens, configured to extend a depth of field of the imaging lens; and
an image sensor, wherein the imaging lens is for imaging the barcode onto the image sensor, and the image sensor converts an image of the barcode into a barcode signal,
wherein the imaging lens comprises a first lens, a second lens, a third lens, a fourth lens and a fifth lens sequentially arranged along a direction from the barcode to the image sensor, and refractive powers of the first lens, the second lens, the third lens, the fourth lens and the fifth lens are sequentially negative, positive, negative, positive and positive.

23. The barcode reading apparatus as claimed in claim 22, further comprising an aperture stop disposed between the second lens and the third lens.

24. The barcode reading apparatus as claimed in claim 22, wherein the first lens and the second lens are aspheric lenses, and the third lens, the fourth lens and the fifth lens are spherical lenses.

25. The barcode reading apparatus as claimed in claim 22, wherein the first lens is a convexo-concave lens with a convex surface facing to the barcode, the second lens is a biconvex lens, the third lens is a biconcave lens, the fourth lens is a concavo-convex lens with a convex surface facing to the image sensor, and the fifth lens is a convexo-concave lens with a convex surface facing to the barcode.

26. The barcode reading apparatus as claimed in claim 22, further comprising a barcode decoder configured to decode the barcode signal to obtain information represented by the barcode.
